(19) United States
(12) Patent Application Publication
(10) Pub. No.: US 2003/0071896 A1
(43) Pub. Date: Apr. 17, 2003

(54) Multiple camera arrangement

(76) Inventor: Andrew Arthur Hunter, Bristol (GB)

Correspondence Address: HEWLETT-PACKARD COMPANY, Intellectual Property Administration, P.O. Box 272400, Fort Collins, CO, 80527-2400, US

(21) Appl. No.: 10/266,695

(22) Filed: Oct. 9, 2002

(30) Foreign Application Priority Data
Oct. 11, 2001 (GB) 0124360.9

(51) Int. Cl. H04N 7/18; H04N 9/47

(52) U.S. Cl. 348/88

(57) ABSTRACT

Image capture apparatus comprising a support of flexible material, in or on which is mounted a plurality of image capture devices. Each image capture device preferably comprises an image sensor, an image buffer and a communications interface, the communications interface of each image capture device being connected to a common set of interconnection lines (or wireless links) providing clock, control and camera data. The shared line (or link) is connected to (or in communication with) a camera control box which may have connected thereto, or integrated therein, a display screen and/or storage means for storing and/or displaying images captured by the image capture devices. Each of the image capture devices has a unique identity so that it is individually addressable, accessible or operable by the camera control box.

### FIELD OF THE INVENTION

This invention relates to an arrangement, such as a security or surveillance system, comprising a plurality of cameras mounted or otherwise disposed in various positions around an area or volume (region) to be monitored.

### BACKGROUND TO THE INVENTION

When it is necessary to view an area or volume (region) which is extended or which contains obstructions, it is frequently necessary to provide a plurality of cameras at spaced locations which between them are capable of covering more of the region than any single camera alone. Examples of such regions include a bank or other place where security is a prime consideration; a public area such as a street or railway platform where it may be necessary to observe a crowd of people for safety reasons, or as an aid to detecting criminal activities; shops where shoplifting is becoming increasingly prevalent; and roads for traffic surveillance. Thus, it is well known to provide within such an area or volume a plurality of image capture devices mounted or otherwise disposed at various key locations so as to provide a surveillance system for monitoring and/or capturing unauthorised activities within the area or volume.

In its simplest form, such a surveillance system comprises a plurality of image capture devices, such as cameras for capturing still or (more commonly) moving images, each of which is linked or connected to a respective display screen or monitor on which the images captured by the devices can be viewed. It is common for an operator to be provided with a bank of monitors showing the pictures coming from each camera. The bank of monitors may or may not be remote from the viewed region. The operator will frequently have the facility to display the picture from any selected camera in greater detail on a primary monitor. Any or all of the plurality of cameras may be adjustable for direction (pan and/or tilt) and/or field of view (focal length or zoom), and the operator may be able to vary these settings on the selected camera while viewing the primary monitor.

If factors such as cost, complexity and/or bandwidth limitations become significant, the size of the monitor bank may be reduced to show pictures from a selection of the cameras. This selection may vary with time so that ultimately pictures from all cameras are seen. A variation of this type of system comprises a plurality of cameras being connected to a single viewing means, such viewing means being arranged to monitor incoming images, detect movement therein and display the images from the device within whose field of view the movement is detected.

Thus, in conventional surveillance systems, a plurality of CCTV cameras or the like are mounted at various locations within the area where surveillance is required, and these cameras are usually wired from those locations back to a video cassette recorder (VCR), a video monitor or a surveillance control systems, as required. As the number of cameras required increases, so does the installation complexity, so that usually only one or two cameras at the most are set up at a single location, thereby substantially restricting the potential range of surveillance angles. If a small number of static cameras cannot cover the whole region of interest then they are often mounted on motorised mechanisms which enable the aim, and therefore the field of view, of such cameras to be changed. Re-aiming cameras often requires human intervention and, in any event, increases the cost of the camera and control system and does not always work very well in the event that there are a number of different objects or locations in the region required to be monitored.

### SUMMARY OF THE INVENTION

In accordance with a first aspect of the present invention, there is provided image capture apparatus, comprising a plurality of image capture devices mounted or otherwise disposed for operation in or on a sheet or strip of flexible material.

In accordance with a second aspect of the present invention, there is provided image capture apparatus comprising a plurality of image capture devices mounted or otherwise disposed, in use, in or on a single support, each of said image capture devices being connected to a common control path and having a unique identity so as to be selectively operable, addressable and/or accessible.

It will be appreciated that the image capture devices need not be identical. The image capture devices included in apparatus according to either aspect of the present invention may have different types of sensor, for example, some may be daylight sensors and some may be infra-red sensors. Further, the image capture devices may have different focal lengths, different resolutions, etc.

In a preferred embodiment of the invention, the image capture devices, which may be operable to capture still and/or moving images, are mounted in or on an elongate strip of flexible material in side-by-side spaced apart relation. In one embodiment, the strip of flexible material or the support may comprise an elongate, transparent or translucent, flexible tube within which said image capture devices are disposed. The strip or support may be comprised of a unitary component, or it may comprise a plurality of composite parts connected together to form the strip or support.

The image capture devices may be very small, i.e. of the order of a few millimetres in width), comprising a lens and a single microchip. In one embodiment, the image capture devices may be implemented in CMOS (which allows sensing and control circuits to be combined in a single, small microchip). Each image capture device preferably comprises an image sensor, an image data processor and storage means for storing one or more captured image frames. Each image capture device is beneficially connected to common clock and/or control and/or data lines which, in turn, are connected to a central control module for controlling the operation of the image capture devices, either individually or collectively, as required. The clock, control and data lines preferably run through the same flexible tube in which the image capture devices are disposed. The control module may be connected to one or more central display and/or storage devices for displaying and/or storing the images captured by the image capture devices.

The control module may include detection apparatus for detecting changes or movement in images captured the image capture devices. Alternatively, or in addition, each of the image capture devices may include local means for detecting changes or movement within their respective captured images, and the apparatus may include switching apparatus for selectively switching the image capture devices on or off, or otherwise reconfiguring them, according to whether or not movement or any other change is detected within their fields of view.

One or more of the image capture devices may include at least two image sensors such that it can capture images from two or more different angles.

Thus, in summary it will be appreciated that the flexible strip or ribbon may be relatively easily attached to a wall or other structure, and bent around comers as required, with the result that it is possible to obtain an image of a subject of interest from an almost arbitrary angle, whereas with conventional surveillance systems it is realistically only possible to obtain images of a subject from one or two angles. In a preferred embodiment of the invention, the strip or ribbon requires only a single connection (wireless or hard-wired) to a camera control box or the like. One or more cameras can be (selectively) activated at any one time. It is even possible to produce a single video sequence made up of successive video frames captured by a sequence of adjacent cameras along the strip or ribbon, giving the same effect as if a single camera had moved its position smoothly relative to a subject during image capture to gain alternative views thereof. Such simulated smooth motion lends itself to substantially easier recognition of the mannerisms and characteristics of an intruder, for example.

Alternatively, still images can be captured simultaneously be means of multiple cameras or in quick succession such that, when the captured images are reviewed in sequence, they appear to come from changing the viewing position of a single camera, even though the activity of the subject is effectively “frozen”. Further, the ability to apparently change the viewing position of the camera(s) and selectively operate or view images from one or more of the plurality of cameras allows a subject to be viewed even when an obstruction blocks the fields of view of a subset of the cameras. Further, it allows the best (most recognisable) views of the subject, such as an intruder, to be selected.

### BRIEF DESCRIPTION OF THE DRAWINGS

An embodiment of the invention will now be described by way of example only and with reference to the accompanying drawings, in which:

FIG. 1 is a schematic block diagram of image capture apparatus according to an exemplary embodiment of the present invention; and

FIG. 2 is a schematic block diagram of an exemplary embodiment of the present invention, when in use in a video conferencing system.

### DETAILED DESCRIPTION OF THE INVENTION

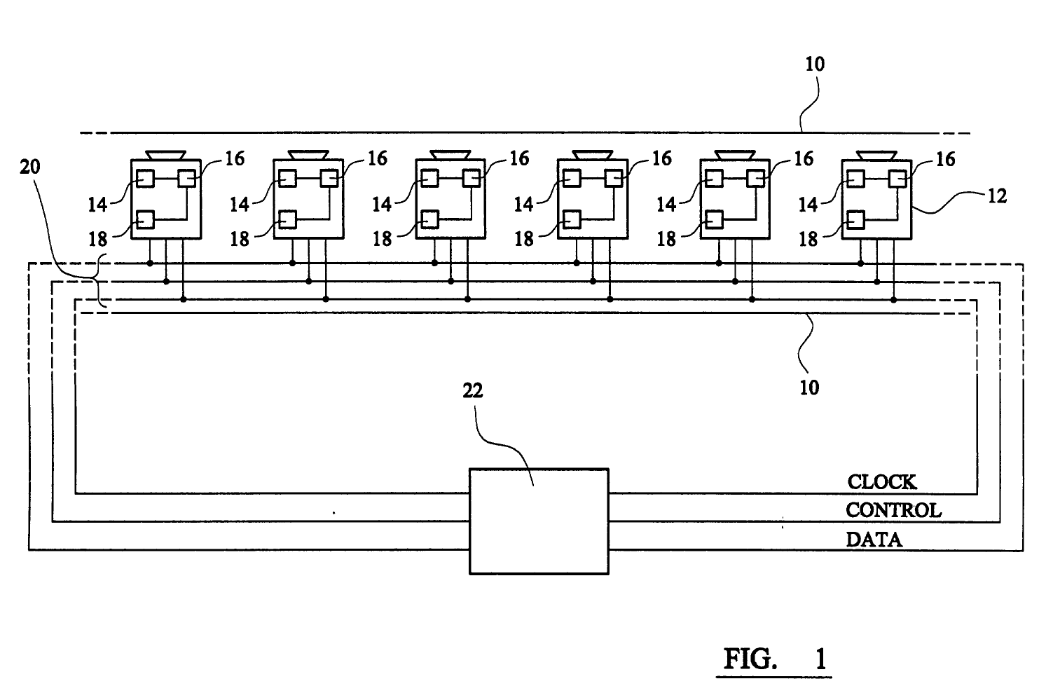

Referring to FIG. 1 of the drawings, image capture apparatus according to an exemplary embodiment of the present invention comprises an elongate tube 10 of flexible, substantially transparent material. A plurality of image capture devices 12 are mounted within the tube 10 in side-by-side, spaced apart relation. Each image capture device 12 or camera comprises an image sensor 14, an image buffer 16 and a communications interface 18. The communications interface 18 of each camera 12 is connected to a common set of interconnection lines 20 providing clock, control and camera data, although in an alternative embodiment, the clock, control and/or data lines may be wireless.

The shared line 20 (which in this case is a hard-wired link, but in an alternative embodiment may be a wireless link) runs along the length of the tube 10, and allows all of the cameras 12 to remain synchronised even if they are not transmitting image data at any one time. The cameras 12 each have a unique identifier so that they can be selectively addressed via the shared control line 20. Similarly, the camera sensors 14 can be configured across the shared control line 20, either together or individually.

In a surveillance system, one or more of the above-described flexible tubes 10 are mounted on the walls or other structures within an area or region to be monitored, the tube(s) being bent around corners as required. The outputs from the cameras 12 are fed to a central camera control box 22 via the shared control line 20. Further, the cameras 12 may be selectively operated, addressed or accessed by the camera control box 22 via the shared control line 20. The camera control box 22 may be connected to, or have integrated therein, a display screen and/or storage means (not shown) for storing and or displaying images captured by the cameras 12.

In order to create a still image with a moveable viewpoint, all of the cameras 12 may be configured and then triggered together and their captured -image data read into their respective image buffers 16. When the image data is required to be viewed, the image sensors 14 of each of the cameras 12 can be identified by their unique ID's and the captured images read out of the respective image buffers 16 in the required sequence according to the relative positions of the cameras 12 in question.

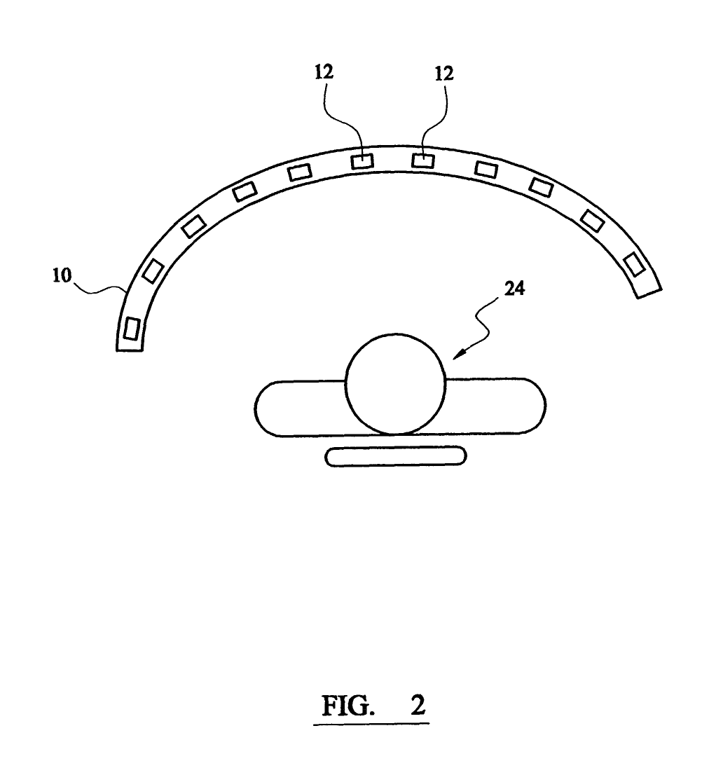

Referring to FIG. 2 of the drawings, the image capture apparatus described above may, alternatively, be used in a video conferencing system, with the flexible tube 10 being mounted or otherwise arranged in a curved or arced configuration around the front of the subject 24, as shown. Thus, it is possible to capture images of a conference participant from multiple angles such that for each other participant displayed on a video display there is a camera looking back from the appropriate angle to convey to that participant an appropriate feeling of eye contact.

Although the present invention has been described above with reference to security or surveillance systems in particular, it will be appreciated that there are many other envisaged uses of the invention. For example, an elongate flexible strip or ribbon carrying a plurality of image capture devices may be used to investigate underground pipes and similar relatively inaccessible structures in order to locate faults, for example. In this case, the strip would not be mounted in a fixed position, but instead one end of the strip would simply be fed through the pipe from one end to the other (manually or otherwise) so that images can be captured and viewed or reviewed to determine the state of the pipe or other structure under investigation.

In yet another embodiment, an elongate flexible ribbon or tube carrying a plurality of image capture devices may be used in medical investigatory procedures, whereby the strip or ribbon may be used as a scope in exploratory surgery, or in providing images for use by a surgeon carrying out keyhole surgery. Of course, the size of image capture devices and length and width of the flexible carrying material would need to be altered according to its intended use.

In the foregoing specification, the invention has been described with reference to specific exemplary embodiments thereof. It will, however, be apparent to a person skilled in the art that various modifications and changes may be made thereto without departing from the broader scope of the invention as set forth in the appended claims. Accordingly, the specification and drawings are to be regarded in an illustrative, rather than a restrictive, sense.

1. Image capture apparatus, comprising a plurality of image capture devices mounted or otherwise disposed for operation in or on a single sheet or strip of flexible material.

2. Image capture apparatus according to claim 1, wherein each of said image capture devices are connected to a common communication path and have a unique identity so as to be selectively operable, addressable and/or accessible.

3. Image capture apparatus, comprising a plurality of image capture devices mounted or otherwise disposed, in use, in or on a single support, each of said image capture devices being connected to a common communication path and having a unique identity so as to be selectively operable, addressable and/or accessible.

4. Image capture apparatus according to claim 3, wherein said plurality of image capture devices are mounted or otherwise disposed in or on a single sheet or strip of flexible material.

5. Image capture apparatus according to claim 1, wherein the strip comprises a unitary part or component.

6. Image capture apparatus according to claim 3, wherein said support comprises a unitary part or component.

7. Image capture apparatus according to claim 1, wherein the strip comprises a plurality of composite parts connected together, in use, to form the strip.

8. Image capture apparatus according to claim 3, wherein the support comprises a plurality of composite parts connected together, in use, to form the support.

9. Image capture apparatus according to claim 1, wherein said image capture devices are mounted in or on an elongate strip of flexible material in side-by-side spaced apart relation.

10. Image capture apparatus according to claim 3, wherein said image capture devices are mounted in or on the support in side-by-side spaced apart relation.

11. Image capture apparatus according to claim 1, wherein said strip of flexible material comprises an elongate, transparent or translucent, flexible tube within which said image capture devices are disposed.

12. Image capture apparatus according to claim 1, wherein each image capture device comprises an image sensor, an image data processor and a storage device for storing one or more captured image frames.

13. Image capture apparatus according to claim 3, wherein each image capture device comprises an image sensor, and image data processor and a storage device for storing one or more captured image frames.

14. Image capture apparatus according to claim 1, wherein each image capture device is connected (either by a hard-wired or wireless connection) to common clock and/or control and/or data lines which are connected (either by a hard-wired or wireless connection) to a central control module for controlling the operation of the image capture devices, either individually, collectively or selectively, as required.

15. Image capture apparatus according to claim 3, wherein each image capture device is connected (either by a hard-wired or wireless connection) to common clock and/or control and/or data lines which are connected (either by a hard-wired or wireless connection) to a central control module for controlling the operation of the image capture devices, either individually, collectively or selectively, as required.

16. Image capture apparatus according to claim 14, wherein the control module is connected (either by a hard-wired or wireless connection) to one or more central display and/or storage devices for displaying and/or storing the images captured by the image capture devices.

17. Image capture apparatus according to claim 15, wherein the control module is connected (either by a hard-wired or wireless connection) to one or more central display and/or storage devices for displaying and/or storing the images captured by the image capture devices.

18. Image capture apparatus according to claim 14, wherein said control module includes detection apparatus for detecting changes and/or movement in images captured by said image capture devices.

19. Image capture apparatus according to claim 15, wherein said control module includes detection apparatus for detecting changes and/or movement in images captured by said image capture devices.

20. Image capture apparatus according to claim 1, wherein each of the image capture devices includes local apparatus for detecting changes and/or movement within their respective fields of view.

21. Image capture apparatus according to claim 3, wherein each of the image capture devices includes local apparatus for detecting changes and/or movement within their respective fields of view.

22. Image capture apparatus according to claim 20, including switching apparatus for selectively switching the image capture devices on or off, or otherwise reconfiguring them, according to whether or not movement or any other changes are detected within their fields of view.

23. Image capture apparatus according to claim 21, including switching apparatus for selectively switching the image capture devices on or off, or otherwise reconfiguring them, according to whether or not movement or any other changes are detected within their fields of view.

24. Image capture apparatus according to claim 1, wherein one or more of said image capture devices includes at least two image sensors.

25. Image capture apparatus according to claim 3, wherein one or more of said image capture devices includes at least two image sensors.

26. Image capture apparatus, comprising a plurality of image capture devices mounted or otherwise disposed for operation in or on a single flexible support, each of said image capture devices being connected to a common communication path and have a unique identity so as to be selectively operable, addressable and/or accessible.
